(19) United States
(12) Patent Application Publication
(10) Pub. No.: US 2024/0253733 A1
(43) Pub. Date: Aug. 1, 2024

(54) HYDROGEN-POWERED MOPED, AND ENERGY SYSTEM AND ENERGY SYSTEM MANAGEMENT METHOD THEREOF

(71) Applicant: YOUON TECHNOLOGY CO., LTD, Changzhou (CN)

(72) Inventors: Cheng QIAN, Changzhou (CN); Jian CEN, Changzhou (CN); Xiang SUN, Changzhou (CN); Weijie ZE, Changzhou (CN)

(73) Assignee: YOUON TECHNOLOGY CO., LTD, Changzhou (CN)

(21) Appl. No.: 18/565,571

(22) PCT Filed: May 27, 2022
(86) PCT No.: PCT/CN2022/095405

§ 371 Date: Nov. 30, 2023

(30) Foreign Application Priority Data
May 31, 2021 (CN) 202110617628.6
May 31, 2021 (CN) 202110635357.7

(51) Int. Cl. B62M 6/90; B62H 5/14; G06Q 30/0645

(52) U.S. Cl. CPC B62M 6/90; B62H 5/14; G06Q 30/0645

(57) ABSTRACT

A hydrogen energy assisted vehicle, comprising a central control system, a hydrogen fuel cell system, a power control system, and a lithium battery pack. The central control system controls the hydrogen fuel cell system and the power control system to work, and receives feedback information of the hydrogen fuel cell system and the power control system. The hydrogen fuel cell system generates electricity to supply power to the central control system, the power control system and the lithium battery pack. The power control system controls the driving speed. The lithium battery pack supplies power to the central control system and the power control system.

### CROSS-REFERENCE TO RELATED APPLICATION(S)

This is a national stage application filed under 37 U.S.C. 371 based on International Patent Application No. PCT/CN2022/095405, filed May 27, 2022, which claims priority to Chinese Patent Application No. 202110635357.7 filed with the China National Intellectual Property Administration (CNIPA) on May 31, 2021, and Chinese Patent Application No. 202110617628.6 filed with the China National Intellectual Property Administration (CNIPA) on May 31, 2021, the disclosure of which is incorporated herein by reference in its entirety.

### TECHNICAL FIELD

The present invention relates to the technical field of hydrogen energy-powered mopeds, in particular to a hydrogen energy-powered moped, and an energy system and energy system management method thereof.

### BACKGROUND

Hydrogen energy-powered mopeds have presented an important inclination to develop mopeds in the future, as they have advantages such as high range endurance and zero emission. However, compared with lithium battery-powered mopeds, since the hydrogen energy-powered mopeds have an additional hydrogen-storing container and hydrogen fuel stack, they need to raise higher requirements for the method how to manage an energy system. At present, the hydrogen energy-powered mopeds still depend on a relatively simple management system, which therefore results in a high failure rate and less favorability experienced by users. Accordingly, there is an urgent need to improve the method for managing the energy system of the hydrogen energy-powered moped.

### SUMMARY

The objective of the present invention is to provide a hydrogen energy-powered moped and an energy system and energy system management method thereof, so as to ensure users a smooth progress for use and enhance users' experience.

In order to achieve the above object, the technical scheme adopted in the present invention is as follows:

Firstly, to provide a hydrogen energy-powered moped, the moped comprises a central control system, a hydrogen fuel cell system, a driving-force control system and a lithium battery pack, the central control system controls the operation of the hydrogen fuel cell system and the driving-force control system, and receives feedback information from the hydrogen fuel cell system and the driving-force control system; the hydrogen fuel cell system generates electric energy to supply electricity to the central control system, the driving-force control system and the lithium battery pack; the driving-force control system controls a driving speed; and the lithium battery pack supplies electricity to the central control system and the driving-force control system.

Further, the central control system includes a central control module, and a rear wheel lock, a hydrogen-storing container lock and front and rear lamps electrically connected to the central control module; the central control module is electrically connected to the hydrogen fuel cell system and the driving-force control system.

Further, the hydrogen fuel cell system includes a hydrogen-storing container, an gas-in solenoid valve, a hydrogen fuel stack and an exhaust solenoid valve communicating with each other in proper order through a pipeline, and a hydrogen fuel cell management module electrically connected to the gas-in solenoid valve, the hydrogen fuel stack and the exhaust solenoid valve; the hydrogen fuel cell management module is electrically connected to the central control system, the driving-force control system and the lithium battery pack.

Further, the hydrogen fuel cell system further includes a pressure transmitter arranged on the pipeline between the gas-in solenoid valve and the hydrogen fuel stack; the pressure transmitter is electrically connected to the hydrogen fuel cell management module.

Further, the hydrogen fuel cell system further includes a temperature sensor arranged on the hydrogen fuel stack; the temperature sensor is electrically connected to the hydrogen fuel cell management module.

Further, the hydrogen fuel cell system further includes a heating module arranged outside the hydrogen-storing container; the heating module is electrically connected to the hydrogen fuel cell management module.

Further, the driving-force control system includes an electric motor controller, and left and right brake handles, a power-assisted sensor and a driving motor electrically connected to the electric motor controller; the electric motor controller is electrically connected to the central control system, the hydrogen fuel cell system and the lithium battery pack.

Further, the central control system and the hydrogen fuel cell system are integrated into a central master system.

Further, the lithium battery pack further comprises the heating unit.

Further, the central master system includes a hydrogen-storing container, an gas-in solenoid valve, a hydrogen fuel stack and an exhaust solenoid valve communicating with each other in proper order through a pipeline, and a central master module electrically connected to the gas-in solenoid valve, the hydrogen fuel stack and the exhaust solenoid valve; the central master module is electrically connected to the driving-force control system and the lithium battery pack; the central master system further includes a pressure transmitter arranged on the pipeline between the gas-in solenoid valve and the hydrogen-storing container; the pressure transmitter is electrically connected to the central master module.

Further, the central control system further includes a rear wheel lock, a hydrogen-storing container lock and front and rear lamps electrically connected to the central control module.

Secondly, the present invention provides an energy system management method of a hydrogen energy-powered moped, wherein the method is used for a hydrogen energy-powered moped, comprising management at the time of an user renting a moped, management at the time of an users returning a moped, and management at the time of a moped lying in the state of waiting for rent,
when an user rents the moped, a central control system unlocks a rear wheel lock and turns on front and rear lamps, and sends an instruction of power-up to a hydrogen fuel cell management system and an electric motor controller, and the hydrogen fuel cell management system starts a hydrogen fuel stack;
when an user returns the moped, a central control system locks a rear wheel lock and turns off front and rear lamps, and sends an instruction of power-off to a hydrogen fuel cell management system and an electric motor controller, so as to cut the power supply to the electric motor controller, the hydrogen fuel stack and the hydrogen fuel cell management system;
when the moped lies in a state of waiting for rent, a central control system determines whether to charge a lithium battery pack based on the residual power of the lithium battery pack, and determines whether to replace a hydrogen-storing container based on the internal pressure of the hydrogen-storing container.

Further, when an user rents the moped, the process of the hydrogen fuel cell management system starting the hydrogen fuel stack is specifically as follows: after the hydrogen fuel cell management system receives an instruction of power-up, it first detects the pressure of the hydrogen-storing container through a pressure transmitter, and detects the temperature of the hydrogen fuel stack through a temperature sensor; if the pressure of the hydrogen-storing container or the temperature of the hydrogen fuel stack does not meet requirements, the hydrogen fuel cell management system will not start the hydrogen fuel stack and concurrently uploads fault information to the central control system; if the pressure of the hydrogen-storing container and the temperature of the hydrogen fuel stack both meet the requirements, then the hydrogen fuel cell management system starts the hydrogen fuel stack and opens a gas-in solenoid valve and a heating module of the hydrogen fuel stack.

Further, during the operation process of the hydrogen fuel stack, the hydrogen fuel cell management system adjusts a rotary speed of the fan of the hydrogen fuel stack and an exhaust frequency of an exhaust solenoid valve according to a temperature sensor and the output power of the hydrogen fuel stack.

Further, when an user returns the moped, after the hydrogen fuel cell management system receives an instruction of power-off, it first detects the residual power of the lithium battery pack; if the residual power of the lithium battery pack is greater than a preset value, the hydrogen fuel cell management system turns off the hydrogen fuel stack; if the residual power of the lithium battery pack is less than a preset value, the hydrogen fuel stack will continue to operate and charge the lithium battery pack until the lithium battery pack gets fully charged, then the hydrogen fuel cell management system cuts the power supply to the hydrogen fuel stack and itself.

Further, when the moped lies in the state of waiting for rent, the process of the central control system determining whether to charge the lithium battery pack based on the residual power of the lithium battery pack is specifically as follows: the central control system evokes the hydrogen fuel cell management system every once in a while, the hydrogen fuel cell management system detects the residual power of the lithium battery pack after it has been evoked; if the residual power of the lithium battery pack is greater than a preset value, the hydrogen fuel cell management system turns off the hydrogen fuel stack; if the residual power of the lithium battery pack is less than a preset value, the hydrogen fuel stack will continue to operate and charge the lithium battery pack until the lithium battery pack gets fully charged, then the hydrogen fuel cell management system cuts the power supply to the hydrogen fuel stack and itself.

Further, when the moped lies in the state of waiting for rent, the process of the central control system determining whether to replace the hydrogen-storing container based on the internal pressure of the hydrogen-storing container is specifically as follows: the central control system evokes the hydrogen fuel cell management system every once in a while, and sends an instruction to inquire about the residual gas volume to the hydrogen fuel cell management system, after the hydrogen fuel cell management system has been evoked, it detects the pressure of the hydrogen-storing container through a pressure transmitter, when the internal pressure of the hydrogen-storing container is lower than a preset value, the central control system notifies maintenance personnel to replace the hydrogen-storing container through a background system, then maintenance personnel send an unlocking instruction to the central control system through a mobile phone, after the central control system receives the instruction, it will unlock a hydrogen-storing container lock, and maintenance personnel will lock the hydrogen-storing container lock after replacing the hydrogen-storing container, concurrently send the information about having replaced the hydrogen-storing container to the background system.

The present invention further provides an energy system of a hydrogen energy-powered moped, which applies the above energy system management method of a hydrogen energy-powered moped.

By adopting the above technical scheme, the present invention has the following beneficial effects:
(1) The hydrogen energy-powered moped of the present invention controls the operation of the hydrogen fuel cell system and the driving-force control system through the central control system and enables the central control system to obtain the operation conditions of the entire moped in time by ways of transmitting the feedback information of the hydrogen fuel cell system and the driving-force control system to the central control system, so that the central control system can control the moped more rationally, thereby reducing maintenance costs and improving users' experience.
(2) The central control system of the hydrogen energy-powered moped of the present invention is provided with the hydrogen-storing container lock that is electrically connected with the central control module, in this way when the hydrogen-storing container needs to be replaced, maintenance personnel can send an instruction of unlocking the hydrogen-storing container to the central control module through a mobile phone, so it is convenient for maintenance personnel to replace the hydrogen-storing container.
(3) The hydrogen fuel stack of the hydrogen energy-powered moped of the present invention is designed to generate electrical energy that is delivered to the central control system, the driving-force control system and the lithium battery pack through the fuel cell management module, so this design can improve the rationality of managing electrical energy and avoid wasting energy.
(4) For the hydrogen fuel cell system of the hydrogen energy-powered moped of the present invention, the pressure transmitter is arranged on the pipeline between the gas-in solenoid valve and the hydrogen fuel stack, in this way when the gas-in pressure of the hydrogen fuel stack is insufficient, maintenance personnel can be notified in time to replace the hydrogen-storing container and turn off the hydrogen fuel stack without delay.
(5) For the hydrogen fuel cell system of the hydrogen energy-powered moped of the present invention, the temperature sensor is set on the hydrogen fuel stack, in this way when the temperature of the hydrogen fuel stack is low, the information is fed back to the central control system, so that the central control system knows that the hydrogen fuel stack cannot start at this time, so as to avoid adverse effects on the service life of the hydrogen fuel stack.
(6) For the hydrogen fuel cell system of the hydrogen energy-powered moped of the present invention, the heating module is set outside the hydrogen-storing container, so as to avoid occurrence of disenabling release of the hydrogen in the hydrogen-storing container in low temperature weather.
(7) The power-assisted sensor electrically connected to the electric motor controller that is set in the driving-force control system of the hydrogen energy-powered moped of the present invention facilitates the system to assist in controlling the rotary speed of the driving motor and improves safety performance.
(8) The further improvement made on the hydrogen energy-powered moped of the present invention is to integrate the central control system with the hydrogen fuel cell management system to combine to form a central master system, which not only saves space, but also facilitates installation for the entire moped.
(9) Another improvement made on the hydrogen energy-powered moped of the present invention is to adjust the pressure transmitter to be positioned behind the gas-in solenoid valve, thereby detecting the pressure of the hydrogen-storing container through the pressure transmitter without opening the gas-in solenoid valve and evoking the hydrogen fuel cell management system, and monitoring the system on standby in real time, furthermore, the improved technical solution reduces system power consumption and saves more power.
(10) The lithium battery pack of the hydrogen energy-powered moped of the present invention may also be provided with the heating unit, the central control system performs detection based on the temperature sensor of the lithium battery, if the temperature is lower than the set value, it starts the heating piece. In this way, there is an additional ambient temperature sampling, which is more suitable for a cold environment such as winter.
(11) In the present invention, the energy system management method of a hydrogen energy-powered moped is divided into three parts: the management at the time of an user renting a moped, the management at the time of an users returning a moped, and the management at the time of a moped lying in the state of waiting for rent, which greatly enhance the rationality of managing the energy system, ensure users a smooth progress for use, greatly enhance users' experience, and strongly promote the development of the hydrogen energy-powered moped.
(12) In the present invention, the hydrogen fuel stack does not start when the pressure of the hydrogen-storing container or the temperature of the hydrogen fuel stack does not meet the requirements, so as to ensure users smooth riding, avoid a midway power break and improve safety.
(13) During the operation process of the hydrogen fuel stack in the present invention, the hydrogen fuel cell management system adjusts the rotary speed of the fan of the hydrogen fuel stack and the exhaust frequency of the exhaust solenoid valve according to the temperature sensor and the output power of the hydrogen fuel stack, not only guaranteeing the efficiency of the hydrogen fuel stack, but also improving safety.
(14) In the present invention, at the time of an user returning a moped, the hydrogen fuel cell management system receives an instruction of power-off, then determines whether to turn off the hydrogen fuel stack based on the residual power of the lithium battery pack, in this way it can ensure that the lithium battery pack has sufficient power.
(15) In the present invention, when the moped is in the state of waiting for rent, the central control system evokes the hydrogen fuel cell management system every once in a while, and the hydrogen fuel cell management system determines whether to charge the lithium battery pack based on the residual power of the lithium battery pack. This operation mode can not only reduce standby power consumption, but also ensure that the lithium battery pack has sufficient power at the time of an user renting a moped next time.
(16) In the present invention, when the moped is in the state of waiting for rent, the central control system evokes the hydrogen fuel cell management system every once in a while, and sends an instruction to inquire about the residual gas volume to the hydrogen fuel cell management system, so as to ensure that maintenance personnel can replace the hydrogen-staring container in time, avoid occurrence of lacking gas in the hydrogen-staring container during an user using a rented moped, and improve users' experience.

### BRIEF DESCRIPTION OF DRAWINGS

FIG. 1 is a block diagram of a hydrogen energy-powered moped.

FIG. 2 is another block diagram of a hydrogen energy-powered moped.

### DETAILED DESCRIPTION

We shall describe the above-mentioned technical solution in detail in combination with the following drawings and examples, so as to enable it to be better understood.

In order to make the objective, the technical solution and the advantage of the examples of the present invention clearer, we shall clearly and completely describe the technical solution in the examples of the present invention in combination with the following drawings in the examples, it is obvious that the described example is part of the embodiments of the present invention, not all of the embodiments. Generally, the components of the examples of the present invention described and shown in the drawings herein can be set up and designed in a variety of different configurations.

Therefore, the detailed descriptions in the examples of the present invention provided in the drawings as follows are not intended to limit the scope of the claimed invention, only represent a selected example of the present invention. Based on the examples in the invention, all other examples obtained by a person skilled in the art without doing the creative work belong to the protection scope of the present invention.

It should be noted that similar marks and letters represent similar items in the following drawings; therefore, once an item is defined in one drawing, it does not need to be further defined and explained in subsequent drawings.

In the description of the examples of the present invention, it should be understood that the orientation or position relation expressed by the terms such as “center”, “up”, “down”, “left”, “right”, “vertical”, “horizontal”, “inside”, “outside” is based on the orientation or position relation shown in the drawings, or the orientation or position relation that the product of the present invention is usually placed during use, or the orientation or position relation as a person skilled in the art usually understands, but it is only for the convenience of describing the present invention and simplifying the description, instead of indicating or implying that the device or component referred to must be arranged in a specific orientation, or be set up and operated in a specific orientation; therefore, it cannot be understood as a limitation on the present invention.

In the description of the examples of the present invention, it should also be noted that, unless otherwise clearly specified and defined, the terms such as “set up”, “install”, “connect”, and “link” should be broadly explained. For example, they may mean a fixed connection, or a detachable connection or a one-piece connection; they may mean a direct connection, or indirect connection through an intermediate medium, or an internal communication between two parts. A person skilled in the art can understand the specific meaning of the above terms corresponding to conditions in the present invention. We shall further describe the present invention in combination with the drawings as follows. The following examples are only used to more clearly describe the technical solution of the present invention, not to impose a limitation on the protection scope of the present invention.

### Example 1

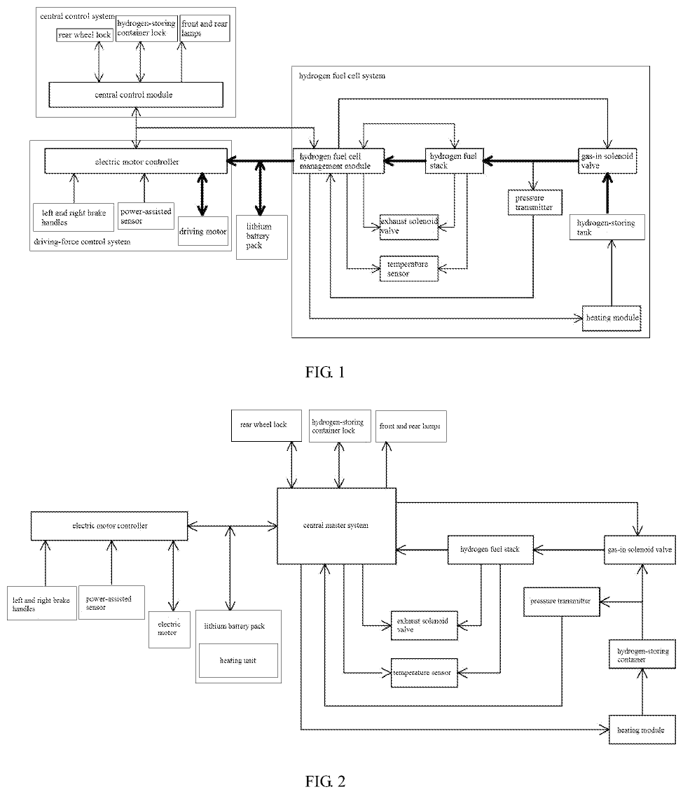

As shown in FIG. 1, the hydrogen energy-powered moped in this example includes a central control system, a hydrogen fuel cell system, a driving-force control system and a lithium battery pack.

The central control system controls the operation of the hydrogen fuel cell system and the driving-force control system, and receives feedback information from the hydrogen fuel cell system and the driving-force control system. The central control system includes a central control module, as well as a rear wheel lock, a hydrogen-storing container lock and front and rear lamps electrically connected to the central control module. The central control system is provided with the hydrogen-storing container lock that is electrically connected with the central control module, in this way when the hydrogen-storing container needs to be replaced, maintenance personnel can send an instruction of unlocking the hydrogen-storing container to the central control module through a mobile phone, so it is convenient for maintenance personnel to replace the hydrogen-storing container. The central control module is electrically connected to the hydrogen fuel cell system and the driving-force control system. The hydrogen energy-powered moped in this example controls the operation of the hydrogen fuel cell system and the driving-force control system through the central control system and enables the central control system to obtain the operation conditions of the entire moped in time by ways of transmitting the feedback information of the hydrogen fuel cell system and the driving-force control system to the central control system, so that the central control system can control the moped more rationally, thereby reducing maintenance costs and improving users' experience.

The hydrogen fuel cell system generates electric energy to supply electricity to the central control system, the driving-force control system and the lithium battery pack. The hydrogen fuel cell system includes a hydrogen-storing container (a hydrogen-storing tank/a hydrogen-storing bottle), an gas-in solenoid valve, a hydrogen fuel stack and an exhaust solenoid valve communicating with each other in proper order through a pipeline, a pressure transmitter arranged on the pipeline between the gas-in solenoid valve and the hydrogen fuel stack, a temperature sensor arranged on the hydrogen fuel stack, a heating module arranged outside the hydrogen-storing container, and a hydrogen fuel cell management module electrically connected to the gas-in solenoid valve, the hydrogen fuel stack, the exhaust solenoid valve, the pressure transmitter, the temperature sensor and the heating module. The hydrogen fuel cell management module is electrically connected to the central control system, the driving-force control system and the lithium battery pack. The main function of the hydrogen fuel cell management module is to collect information from the pressure transmitter and the temperature sensor, and control the operation of the gas-in solenoid valve, the hydrogen fuel stack, the exhaust solenoid valve and the heating module. The hydrogen fuel stack is designed to generate electrical energy that is delivered to the central control system, the driving-force control system and the lithium battery pack through the fuel cell management module, so this design can improve the rationality of managing electrical energy and avoid wasting energy. The pressure transmitter is arranged on the pipeline between the gas-in solenoid valve and the hydrogen fuel stack, in this way when the gas-in pressure of the hydrogen fuel stack is insufficient, maintenance personnel can be notified in time to replace the hydrogen-storing container and turn off the hydrogen fuel stack without delay. The temperature sensor is set on the hydrogen fuel stack, in this way when the temperature of the hydrogen fuel stack is low, the information is fed back to the central control system, so that the central control system knows that the hydrogen fuel stack cannot start at this time, so as to avoid adverse effects on the service life of the hydrogen fuel stack. The heating module is set outside the hydrogen-storing container, so as to avoid occurrence of disenabling release of the hydrogen in the hydrogen-storing container in low temperature weather.

The driving-force control system controls the driving speed, and the lithium battery pack supplies electricity to the central control system and the driving-force control system. The driving-force control system includes an electric motor controller, and left and right brake handles, a power-assisted sensor and a driving motor electrically connected to the electric motor controller. The electric motor controller is electrically connected to the central control system, the hydrogen fuel cell system and the lithium battery pack. The main function of the electric motor controller is to receive signals from the left and right brake handles and the power-assisted sensor, drive the driving motor to rotate, and control the rotary speed of the driving motor. The power-assisted sensor electrically connected to the electric motor controller is set to facilitate the system to assist in controlling the rotary speed of the driving motor and improves safety performance.

### Example 2

As shown in FIG. 2, it is a block diagram of an improved hydrogen energy-powered moped.

Compared with Example 1, this example mainly has three changes.
1. An improvement made on the hydrogen energy-powered moped is to integrate the central control system with the hydrogen fuel cell management system to combine to form a central master system, which not only saves space, but also facilitates installation for the entire moped.
2. Another improvement made on the hydrogen energy-powered moped is to adjust the pressure transmitter to be positioned behind the gas-in solenoid valve, thereby detecting the pressure of the hydrogen-storing container through the pressure transmitter without opening the gas-in solenoid valve and evoking the hydrogen fuel cell management system, and monitoring the system on standby in real time, furthermore, the improved technical solution reduces system power consumption and saves more power.
3. The lithium battery pack is provided with the heating unit, the central control system performs detection based on the temperature sensor of the lithium battery, if the temperature is lower than the set value, it starts the heating piece. In this way, there is an additional ambient temperature sampling, which is more suitable for a cold environment such as winter.

### Example 3

The hydrogen energy-powered moped in this example includes an energy system, and the management method for this energy system includes the management at the time of an user renting a moped, the management at the time of an users returning a moped, and the management at the time of a moped lying in the state of waiting for rent.

When an user rents the moped, the central control system unlocks the rear wheel lock and turns on the front and rear lamps, and sends an instruction of power-up to the hydrogen fuel cell management system and the electric motor controller, and the hydrogen fuel cell management system starts the hydrogen fuel stack; the process of starting the hydrogen fuel stack is specifically as follows: after the hydrogen fuel cell management system receives an instruction of power-up, it first detects the pressure of the hydrogen-storing container through the pressure transmitter, and detects the temperature of the hydrogen fuel stack through the temperature sensor; if the pressure of the hydrogen-storing container or the temperature of the hydrogen fuel stack does not meet the requirements, the hydrogen fuel cell management system will not start the hydrogen fuel stack and concurrently uploads fault information to the central control system; if the pressure of the hydrogen-storing container and the temperature of the hydrogen fuel stack both meet the requirements, then the hydrogen fuel cell management system starts the hydrogen fuel stack and opens the gas-in solenoid valve and the heating module of the hydrogen fuel stack, so as to ensure users smooth riding, avoid a midway power break and improve safety.

During the operation process of the hydrogen fuel stack, the hydrogen fuel cell management system adjusts the rotary speed of the fan of the hydrogen fuel stack and the exhaust frequency of the exhaust solenoid valve according to the temperature sensor and the output power of the hydrogen fuel stack, not only guaranteeing the efficiency of the hydrogen fuel stack, but also improving safety.

When an user returns the moped, the central control system locks the rear wheel lock and turns off the front and rear lamps, and sends an instruction of power-off to the hydrogen fuel cell management system and the electric motor controller, so as to cut the power supply to the electric motor controller, the hydrogen fuel stack and the hydrogen fuel cell management system; specifically, after the hydrogen fuel cell management system receives an instruction of power-off, it first detects the residual power of the lithium battery pack; if the residual power of the lithium battery pack is greater than a preset value, the hydrogen fuel cell management system turns off the hydrogen fuel stack; if the residual power of the lithium battery pack is less than a preset value, the hydrogen fuel stack will continue to operate and charge the lithium battery pack until the lithium battery pack gets fully charged, then the hydrogen fuel cell management system cuts the power supply to the hydrogen fuel stack and itself, so as to ensure that the lithium battery pack has sufficient power.

When the moped lies in the state of waiting for rent, the central control system determines whether to charge the lithium battery pack based on the residual power of the lithium battery pack, and determines whether to replace the hydrogen-storing container based on the internal pressure of the hydrogen-storing container. The process of the central control system determining whether to charge the lithium battery pack based on the residual power of the lithium battery pack is specifically as follows: the central control system evokes the hydrogen fuel cell management system every once in a while, the hydrogen fuel cell management system detects the residual power of the lithium battery pack after it has been evoked; if the residual power of the lithium battery pack is greater than a preset value, the hydrogen fuel cell management system turns off the hydrogen fuel stack; if the residual power of the lithium battery pack is less than a preset value, the hydrogen fuel stack will continue to operate and charge the lithium battery pack until the lithium battery pack gets fully charged, then the hydrogen fuel cell management system cuts the power supply to the hydrogen fuel stack and itself, this operation mode can not only reduce standby power consumption, but also ensure that the lithium battery pack has sufficient power at the time of an user renting a moped next time.

The process of the central control system determining whether to replace the hydrogen-storing container based on the internal pressure of the hydrogen-storing container is specifically as follows: the central control system evokes the hydrogen fuel cell management system every once in a while, and sends an instruction to inquire about the residual gas volume to the hydrogen fuel cell management system, after the hydrogen fuel cell management system has been evoked, it detects the pressure of the hydrogen-storing container through the pressure transmitter, when the internal pressure of the hydrogen-storing container is lower than a preset value, the central control system notifies maintenance personnel to replace the hydrogen-storing container through a background system. That is, the central control system sends the information about needing to replace the hydrogen-storing container, after the background system receives the information; it sends the information about the replacement of the hydrogen-storing container downwards to the mobile phone of maintenance personnel near the hydrogen-storing container. Then maintenance personnel send an unlocking instruction to the central control system through a mobile phone, after the central control system receives the instruction, it will unlock the hydrogen-storing container lock, and maintenance personnel will lock the hydrogen-storing container lock after replacing the hydrogen-storing container, concurrently send the information about having replaced the hydrogen-storing container to the background system, after the background system receives it, the system updates the information of the vehicle where the hydrogen-storing container is located, and refreshes the information about the vehicle's range. In this way, it can ensure that maintenance personnel replace the hydrogen-staring container in time, avoids occurrence of lacking gas in the hydrogen-staring container during an user using a rented moped, and improves users' experience.

In this example, the energy system management method of a hydrogen energy-powered moped is divided into three parts: the management at the time of an user renting a moped, the management at the time of an users returning a moped, and the management at the time of a moped lying in the state of waiting for rent, which greatly enhance the rationality of managing the energy system, ensure users a smooth progress for use, greatly enhance users' experience, and strongly promote the development of the hydrogen energy-powered moped.

As described in the above specific examples, the objective, the technical solution and the beneficial effect of the present invention are further described in detail. It should be understood that the above description are only specific examples of the present invention, not used to limit the present invention. Any modification, equivalent replacement, improvement and the likes made within the essence and principle of the present invention shall fall within the protection scope of the present invention.

What is claimed is:

1. A hydrogen energy-powered moped, wherein the moped comprises a central control system, a hydrogen fuel cell system, a driving-force control system and a lithium battery pack, the central control system controls the operation of the hydrogen fuel cell system and the driving-force control system, and receives feedback information from the hydrogen fuel cell system and the driving-force control system; the hydrogen fuel cell system generates electric energy to supply electricity to the central control system, the driving-force control system and the lithium battery pack; the driving-force control system controls a driving speed; and the lithium battery pack supplies electricity to the central control system and the driving-force control system.

2. The hydrogen energy-powered moped according to claim 1, wherein the central control system includes a central control module, and a rear wheel lock, a hydrogen-storing container lock and front and rear lamps electrically connected to the central control module; the central control module is electrically connected to the hydrogen fuel cell system and the driving-force control system.

3. The hydrogen energy-powered moped according to claim 1, wherein the hydrogen fuel cell system includes a hydrogen-storing container, an gas-in solenoid valve, a hydrogen fuel stack and an exhaust solenoid valve communicating with each other in proper order through a pipeline, and a hydrogen fuel cell management module electrically connected to the gas-in solenoid valve, the hydrogen fuel stack and the exhaust solenoid valve; the hydrogen fuel cell management module is electrically connected to the central control system, the driving-force control system and the lithium battery pack.

4. The hydrogen energy-powered moped according to claim 3, wherein the hydrogen fuel cell system further includes a pressure transmitter arranged on the pipeline between the gas-in solenoid valve and the hydrogen fuel stack; the pressure transmitter is electrically connected to the hydrogen fuel cell management module.

5. The hydrogen energy-powered moped according to claim 3, wherein the hydrogen fuel cell system further includes a temperature sensor arranged on the hydrogen fuel stack; the temperature sensor is electrically connected to the hydrogen fuel cell management module.

6. The hydrogen energy-powered moped according to claim 3, wherein the hydrogen fuel cell system further includes a heating module arranged outside the hydrogen-storing container; the heating module is electrically connected to the hydrogen fuel cell management module.

7. The hydrogen energy-powered moped according to claim 1, wherein the driving-force control system includes an electric motor controller, and left and right brake handles, a power-assisted sensor and a driving motor electrically connected to the electric motor controller; the electric motor controller is electrically connected to the central control system, the hydrogen fuel cell system and the lithium battery pack.

8. The hydrogen energy-powered moped according to claim 1, wherein the central control system and the hydrogen fuel cell system are integrated into a central master system.

9. (canceled)

10. The hydrogen energy-powered moped according to claim 8, wherein the central master system includes a hydrogen-storing container, an gas-in solenoid valve, a hydrogen fuel stack and an exhaust solenoid valve communicating with each other in proper order through a pipeline, and a central master module electrically connected to the gas-in solenoid valve, the hydrogen fuel stack and the exhaust solenoid valve; the central master module is electrically connected to the driving-force control system and the lithium battery pack; the central master system further includes a pressure transmitter arranged on the pipeline between the gas-in solenoid valve and the hydrogen-storing container; the pressure transmitter is electrically connected to the central master module.

11. (canceled)

12. An energy system management method of a hydrogen energy-powered moped, wherein the method is used for a hydrogen energy-powered moped, comprising management at the time of an user renting a moped, management at the time of an users returning a moped, and management at the time of a moped lying in the state of waiting for rent,
when an user rents the moped, a central control system unlocks a rear wheel lock and turns on front and rear lamps, and sends an instruction of power-up to a hydrogen fuel cell management system and an electric motor controller, and the hydrogen fuel cell management system starts a hydrogen fuel stack;
when an user returns the moped, a central control system locks a rear wheel lock and turns off front and rear lamps, and sends an instruction of power-off to a hydrogen fuel cell management system and an electric motor controller, so as to cut the power supply to the electric motor controller, the hydrogen fuel stack and the hydrogen fuel cell management system;
when the moped lies in a state of waiting for rent, a central control system determines whether to charge a lithium battery pack based on the residual power of the lithium battery pack, and determines whether to replace a hydrogen-storing container based on the internal pressure of the hydrogen-storing container;
wherein when the moped lies in the state of waiting for rent, the process of the central control system determining whether to charge the lithium battery pack based on the residual power of the lithium battery pack is specifically as follows: the central control system evokes the hydrogen fuel cell management system every once in a while, the hydrogen fuel cell management system detects the residual power of the lithium battery pack after it has been evoked; if the residual power of the lithium battery pack is greater than a preset value, the hydrogen fuel cell management system turns off the hydrogen fuel stack; if the residual power of the lithium battery pack is less than a preset value, the hydrogen fuel stack will continue to operate and charge the lithium battery pack until the lithium battery pack gets fully charged, then the hydrogen fuel cell management system cuts the power supply to the hydrogen fuel stack and itself.

13. The energy system management method according to claim 12, wherein when an user rents the moped, the process of the hydrogen fuel cell management system starting the hydrogen fuel stack is specifically as follows: after the hydrogen fuel cell management system receives an instruction of power-up, it first detects the pressure of the hydrogen-storing container through a pressure transmitter, and detects the temperature of the hydrogen fuel stack through a temperature sensor; if the pressure of the hydrogen-storing container or the temperature of the hydrogen fuel stack does not meet requirements, the hydrogen fuel cell management system will not start the hydrogen fuel stack and concurrently uploads fault information to the central control system; if the pressure of the hydrogen-storing container and the temperature of the hydrogen fuel stack both meet the requirements, then the hydrogen fuel cell management system starts the hydrogen fuel stack and opens a gas-in solenoid valve and a heating module of the hydrogen fuel stack.

14. The energy system management method according to claim 12, wherein during the operation process of the hydrogen fuel stack, the hydrogen fuel cell management system adjusts a rotary speed of the fan of the hydrogen fuel stack and an exhaust frequency of an exhaust solenoid valve according to a temperature sensor and the output power of the hydrogen fuel stack.

15. The energy system management method according to claim 12, wherein when an user returns the moped, after the hydrogen fuel cell management system receives an instruction of power-off, it first detects the residual power of the lithium battery pack; if the residual power of the lithium battery pack is greater than a preset value, the hydrogen fuel cell management system turns off the hydrogen fuel stack; if the residual power of the lithium battery pack is less than a preset value, the hydrogen fuel stack will continue to operate and charge the lithium battery pack until the lithium battery pack gets fully charged, then the hydrogen fuel cell management system cuts the power supply to the hydrogen fuel stack and itself.

16. (canceled)

17. The energy system management method according to claim 12, wherein when the moped lies in the state of waiting for rent, the process of the central control system determining whether to replace the hydrogen-storing container based on the internal pressure of the hydrogen-storing container is specifically as follows: the central control system evokes the hydrogen fuel cell management system every once in a while, and sends an instruction to inquire about the residual gas volume to the hydrogen fuel cell management system, after the hydrogen fuel cell management system has been evoked, it detects the pressure of the hydrogen-storing container through a pressure transmitter, when the internal pressure of the hydrogen-storing container is lower than a preset value, the central control system notifies maintenance personnel to replace the hydrogen-storing container through a background system, then maintenance personnel send an unlocking instruction to the central control system through a mobile phone, after the central control system receives the instruction, it will unlock a hydrogen-storing container lock, and maintenance personnel will lock the hydrogen-storing container lock after replacing the hydrogen-storing container, concurrently send the information about having replaced the hydrogen-storing container to the background system.

18. (canceled)
